(19) United States
(12) Patent Application Publication
(10) Pub. No.: US 2023/0123156 A1
(43) Pub. Date: Apr. 20, 2023

(54) Method For Producing A Waveguide

(71) Applicants: Tesat-Spacecom GmbH & Co. KG, Backnang (DE); TRUMPF Laser - und Systemtechnik GmbH (TLD), Ditzingen (DE)

(72) Inventors: Ralf Bölter, Backnang (DE); Andreas Scheffel, Backnang (DE); Ingo Krüger, Backnang (DE); Matthias Herte, Backnang (DE); Helmut Reis, Ditzingen (DE)

(73) Assignees: Tesat-Spacecom GmbH & Co. KG, Backnang (DE); TRUMPF Laser - und Systemtechnik GmbH (TLD), Ditzingen (DE)

(21) Appl. No.: 17/910,186

(22) PCT Filed: Mar. 4, 2021
(86) PCT No.: PCT/EP2021/055490

§ 371 Date: Sep. 8, 2022

(30) Foreign Application Priority Data
Mar. 10, 2020 (DE) 102020106405.5

(51) Int. Cl. H01P 1/04; B23K 26/32; H01P 5/02; H01P 11/00; B23K 26/26

(52) U.S. Cl. CPC H01P 1/042; B23K 26/32; H01P 5/02; H01P 11/002; B23K 26/26; B23K 2101/38

(57) ABSTRACT

A method for producing a hollow conductor is specified. The hollow conductor has a first hollow-conductor section and a connecting section. The first hollow-conductor section contains a non-weldable aluminium alloy and the connecting section contains a weldable aluminium alloy. The method includes the step of: connecting the first hollow-conductor section to the connecting section by a laser-welding method.

### TECHNICAL FIELD

The present description relates to a method for producing a waveguide and to a waveguide which is produced or assembled from a plurality of individual components. In particular, the description relates to an approach for producing a waveguide using laser welding techniques.

### BACKGROUND

Waveguides are usually used to transmit high-frequency electromagnetic signals. For example, waveguides are used in communication satellites to transmit electromagnetic signals, such as, for example, signals which are transmitted in a signal transmission path between electrical components, such as amplifiers, and transmitting/receiving elements.

The construction and use of waveguides and the tuning of resonators in waveguides is described, for example, in DE 10 2016 107 955 A1.

Waveguides are typically produced from a plurality of individual pieces. Here, the individual components are generally produced and made available as standard components and individually assembled and connected to one another for a specific application.

An example of a mechanical connector for assembling two waveguide sections is shown in DE 10 2016 125 084 A1.

Another technique for connecting individual waveguide sections to form a waveguide is salt bath brazing. However, salt bath brazing entails various disadvantages and generally requires high and complex safety precautions. Soft soldering is usually used for silver-plated surfaces, but typically at points with low thermal stress.

### DESCRIPTION

The object can be considered to be that of simplifying the assembly of individual waveguide sections to form a waveguide and achieving a high-quality connection.

This object is achieved by the subject matter of the independent claims. Further embodiments will be found in the dependent claims and the following description.

According to a first aspect, a method for producing a waveguide is specified. The method is applied to a waveguide which is assembled from a first waveguide section and a connecting section or has these two components. The first waveguide section contains a non-weldable aluminum alloy and the connecting section contains a weldable aluminum alloy. The method comprises the step of: connecting the first waveguide section to the connecting section by means of a laser welding method.

In the context of this description, a weldable aluminum alloy is to be understood as an aluminum alloy which can be welded without a welding filler material. Conversely, a non-weldable aluminum alloy is to be understood as an aluminum alloy which can only be welded with a welding filler material. The weldable aluminum alloy is thus weldable intrinsically and on its own, whereas the non-weldable aluminum alloy is not weldable intrinsically and on its own.

The first waveguide section can have an elongate and/or straight shape. The waveguide is assembled from a plurality of components in order to adapt the waveguide to a specific application. Thus, the waveguide can consist of or be assembled from two or more individual sections. It is conceivable for the first waveguide section and/or the connecting section to have a curved shape, for example in order to produce a waveguide with a desired profile.

The sections from which the waveguide is assembled can each be present individually as standard parts. According to the approach described herein, it is envisaged that a waveguide section made of a non-weldable aluminum alloy is welded to a connecting section made of a weldable aluminum alloy by means of laser welding.

Laser welding is a welding process in which laser radiation is focused on a location to be welded. The energy supplied by means of the laser radiation heats the components to be welded to a temperature above the melting temperature of at least one of the components to be welded. As the components cool, a weld seam is then formed. For the method described here, laser welding can be carried out with or without welding filler materials. By virtue of the fact that one of the sections consists of or contains a weldable aluminum alloy, it is possible in principle to dispense with a welding filler material, further simplifying the method.

The method makes it possible to assemble and produce a waveguide from a plurality of sections (first waveguide section, connecting section) with little effort. This is made possible, in particular, by virtue of the fact that, of two sections to be connected, only one has to comprise a weldable aluminum alloy. The other section can also comprise a non-weldable aluminum alloy. It is nevertheless possible, in this assembly process by means of laser welding, to form a weld seam which is adequate for the purposes of the waveguide produced in this way in order to ensure the signal transmission properties required for a waveguide.

In other words, by means of laser welding, an element comprising a weldable aluminum alloy is welded to an element comprising a non-weldable aluminum alloy in order to produce a waveguide described here. During the welding process, laser welding produces in the region of the weld seam a very dynamic melt, in which the constituents of the weldable aluminum alloy and of the non-weldable aluminum alloy are thoroughly mixed. This makes it possible to weld the section comprising a weldable aluminum alloy to the section comprising a non-weldable aluminum alloy without a filler material.

It is conceivable for the method to be used with waveguide sections made of metallic materials other than aluminum, but one of the sections is laser-weldable and the other is non-weldable.

Whether a material is to be categorized as weldable or non-weldable depends on its weldability by means of laser welding.

The connecting section, which contains a weldable aluminum alloy, can, in particular, be a small and/or complex part of the waveguide, such as, for example, an angle piece. In this way, the long, straight sections can continue to be manufactured from non-weldable material or contain a non-weldable material.

According to one embodiment, the method further comprises: placing the connecting section with respect to the first waveguide section, such that the connecting section rests against the first waveguide section at least pointwise, and connecting the first waveguide section to the connecting section by means of the laser welding method where the connecting section rests against the first waveguide section.

The first waveguide section rests against the connecting section if these two sections are placed close together or against one another at least pointwise, thus enabling a connection to be made by means of laser welding at these locations where the two sections rest against one another. The first waveguide section and the connecting section can rest against one another, can lie one on top of the other or can be inserted partially one inside the other, and then be welded to one another.

According to a further embodiment, the method further comprises: placing the connecting section with respect to the first waveguide section, such that the connecting section partially overlaps the first waveguide section in the longitudinal direction of the first waveguide section.

It is thus possible to produce a waveguide whose signal transmission properties have a high quality in the intended high-frequency range.

According to a further embodiment, the connecting section completely surrounds the first waveguide section in the circumferential direction.

The connecting section is thus plugged or pushed onto the first waveguide section. Of course, it is also conceivable and possible for the first waveguide section to be plugged or pushed onto the connecting section. It is possible to use the variant which simplifies the process of laser welding in the respective application.

According to a further embodiment, the waveguide comprises a second waveguide section, wherein the second waveguide section adjoins the connecting section.

The connecting section is accordingly located between the first waveguide section and the second waveguide section and is used to connect the first waveguide section and the second waveguide section to one another and to form a waveguide.

According to a further embodiment, the second waveguide section is of one-piece design with the connecting section.

In this embodiment, the connecting section is part of the second waveguide section. The connecting section can form an end of the second waveguide section which is used for connection/welding to the first waveguide section. In this embodiment, a single weld seam may be sufficient to produce the waveguide.

According to a further embodiment, the connecting section is configured as a sleeve which at least partially overlaps both the first waveguide section and the second waveguide section in the longitudinal direction and completely surrounds them in the circumferential direction on a respective outer surface, wherein the sleeve is connected to the first waveguide section and the second waveguide section by means of laser welding.

This embodiment envisages that the connecting section is a separate component and is used to connect the first waveguide section to the second waveguide section. In this connection, two separate weld seams can be formed in order to weld the connecting section to the first waveguide section, on the one hand, and to the second waveguide section, on the other hand.

If the first and second waveguide sections are inserted into the sleeve (or vice versa), this can increase the mechanical stability of the waveguide because the overlap in the insertion region ensures this stability.

According to a further embodiment, the second waveguide section contains a non-weldable aluminum alloy.

The sleeve, which consists of or contains a weldable aluminum alloy, is therefore suitable for connecting two waveguide sections made of non-weldable material to one another.

According to a further embodiment, the weldable aluminum alloy has a silicon content of more than 3 percent by weight, and the non-weldable aluminum alloy has a silicon content of at most 3 percent by weight.

In principle, an alloy according to the specifications of the 3000, 4000 and 500 series according to AWS (American Welding Society) or similar compositions is suitable for the section or sections made of weldable material. For the section or sections made of non-weldable material, an alloy according to the specifications of the 2000, 6000 and 7000 series according to AWS or similar compositions is suitable.

In the 2000 series (AlCu), copper is the main alloying component. The 3000 series (AlMn) has manganese as the main alloying component. The 4000 series (AlSi) has silicon as the main alloying component. The 5000 series (AlMg) has magnesium as the main alloying component. The 6000 series (AlMgSi) is an alloy containing silicon and magnesium. The 7000 series (AlZn) has zinc as the main alloy.

In one example, and particularly preferably, the first waveguide section comprises a material from the AWS-6000 series, and the connecting section comprises a material from the AWS-4000 series.

According to a further aspect, a waveguide for transmitting high-frequency signals is specified. The waveguide has a first waveguide section, which has a non-weldable aluminum alloy, and a connecting section, which contains a weldable aluminum alloy. The first waveguide section and the connecting section are connected to one another by means of a laser weld seam.

At least in a region in which it is welded to the first waveguide section, the connecting section contains a weldable aluminum alloy.

Structural features of the waveguide have also been described with reference to the method. These structural features also count as features of the waveguide as such, without specific reference to the production method. That is to say that what has been described with reference to the method also applies mutatis mutandis to the waveguide as such.

### BRIEF DESCRIPTION OF THE FIGURES

Exemplary embodiments of the invention are explained in greater detail below with reference to the attached drawings. The illustrations are schematic and not to scale. Identical reference signs refer to identical or similar elements. More specifically:

FIG. 1 shows a schematic isometric illustration of a waveguide according to one exemplary embodiment.

FIG. 2 shows a schematic illustration of a connecting section of a waveguide according to a further exemplary embodiment.

FIG. 3 shows a schematic illustration of the cross section of a connecting section of a waveguide according to a further exemplary embodiment.

FIG. 4 shows a schematic illustration of the cross section of a waveguide according to a further exemplary embodiment.

FIG. 5 shows a schematic illustration of the cross section of a waveguide according to a further exemplary embodiment.

FIG. 6 shows a schematic illustration of the cross section of a waveguide according to a further exemplary embodiment.

FIG. 7 shows a schematic illustration of the cross section of a waveguide according to a further exemplary embodiment.

FIG. 8 shows a schematic illustration of the steps of a method according to a further exemplary embodiment.

### DETAILED DESCRIPTION OF EXEMPLARY EMBODIMENTS

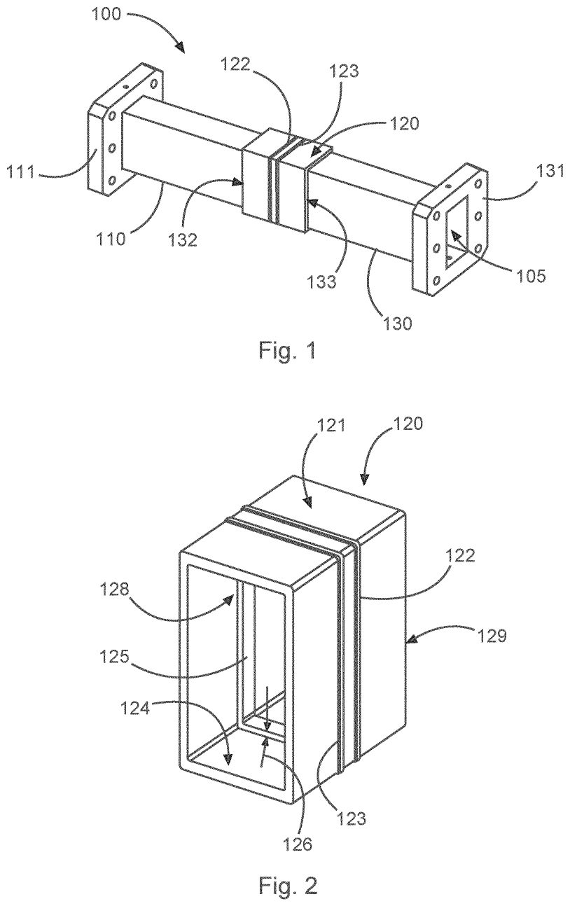

FIG. 1 shows a waveguide 100 consisting of a first waveguide section 110, a connecting section 120, and a second waveguide section 130. The first waveguide section 110 is connected to the second waveguide section 120 by means of the connecting section 130.

The waveguide 100 forms a cavity 105, in which an electromagnetic wave can propagate. The cavity 105 can have different geometries, which can be adapted to the signals to be transmitted. Therefore, the rectangular cross section of the cavity 105 shown here should not be regarded as limiting the shape of the cross section of the cavity.

At their opposite ends, both waveguide sections 110, 130 each have a flange 111, 131, which is used to connect the waveguide 110 to adjacent components. The flanges are connected to an adjacent component, by means of screws for example, for which purpose the holes in the flanges 111, 131 are used.

In the example of FIG. 1, the waveguide sections 110, 130 are manufactured from a non-weldable aluminum alloy. The connecting section 120 is a sleeve, which is connected to the waveguide sections 110, 130 by means of laser weld seams 122, 123.

The connecting section 120 is configured in such a way that the waveguide sections 110, 130 can each be inserted into a respective opening in the sleeve from opposite directions. The path of the weld seams 122, 123 can be marked on the outer surface of the sleeve. A laser welding device can then move over this marking and, in the process, produce the weld seam. Each weld seam 122, 123 establishes a connection between the sleeve and a waveguide section 110, 130.

In the example of FIG. 1, two further weld seams 132 and 133 are placed at the opposite ends of the connecting section 120 and connect these ends to the outer surface of one of the waveguide sections 110, 130 in each case. Open spaces between the sleeve and the waveguide sections are thereby avoided. The weld seams 122 and 123 provide the primary electrical connection between the two waveguides, and the weld seams 132 and 133 offer increased mechanical strength.

FIG. 2 shows a view of the connecting section 120 without the waveguide sections 110, 130. The connecting section 120 has an outer surface 121 and an inner surface 124. The waveguide sections 110, 130 rest against the inner surface 124 when they are inserted into the connecting section 120.

On the inner surface 124, the connecting section 120 has a projection 125 running around the inside. The projection extends from the inner surface 124 in the direction of the central opening of the connecting section, i.e. away from the inner surface, and has a height 126.

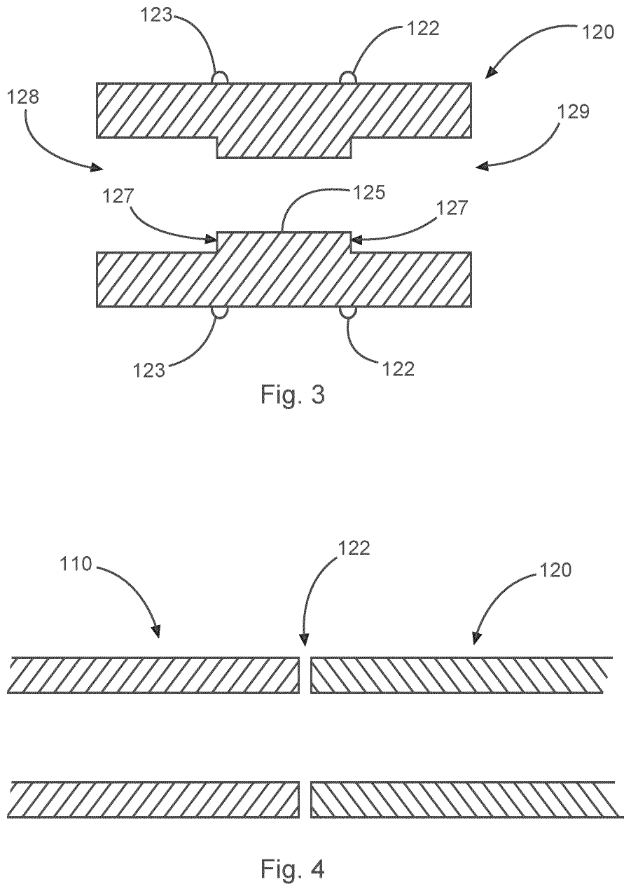

The projection 125 forms two abutment surfaces 127 (see FIG. 3), which face in the direction of the openings of the connecting section. The abutment surfaces preferably extend perpendicularly away from the inner surface. The abutment surfaces serve to contact the ends of the waveguide sections 110, 130 when the waveguide sections 110, 130 are inserted into the connecting section 120. The abutment surfaces thus determine the position of the waveguide sections in the connecting section. In order to produce a reliable connection between the connecting section and the waveguide sections, the waveguide sections are pushed into the connecting section until one end of the respective waveguide section abuts the abutment surface.

The projection 125 has a height 126. This height preferably corresponds to the material thickness of the waveguide sections to be connected. There is thus no significant change in the cross section in the cavity 105 of the assembled waveguide 110, which is advantageous for the propagation of an electromagnetic wave in the waveguide.

It is possible to use a sleeve without a projection 125 on the inner surface. In this case, the two waveguide sections pushed into the sleeve are pushed in until their end faces adjoin one another. A weld seam can then be produced at the location at which the end faces of the waveguide sections adjoin one another, and the molten material connects the two waveguide sections within the sleeve.

FIG. 3 shows a schematic sectional view of the connecting section 120. The projection 125 arranged on the inner surface of the connecting section extends over the entire circumference of the connecting section. However, FIG. 3 shows only the sectioned areas.

The projection 125 has two abutment surfaces 127, which face in the direction of the openings 128, 129 arranged at opposite ends of the connecting section. The waveguide sections 110, 130 are inserted into the openings in the connecting section and pushed in until they rest against the abutment surfaces 127.

The path of the weld seams 122, 123 is shown on the outer surface 121 of the connecting section. The weld seams run along the abutment surfaces in the circumferential direction of the projection. In this way, a laser welding device can produce the weld seams when a corresponding laser beam is directed onto the outer surface and moved along the intended weld seam path. During this process, a connection is produced between the connecting section and the waveguide section, specifically in the region of the abutment surfaces 127. The path of the weld seams can be marked on the outer surface.

When the waveguide sections 110, 130 are pushed into the openings 128, 129 of the connecting section and are welded to the connecting section, the projection 125 and the cavities of the waveguide sections form a uniform cavity which extends over the entire length of the waveguide. The cross section of the cavity changes hardly at all or changes only imperceptibly along the longitudinal direction of the waveguide. This is made possible, in particular, by virtue of the fact that the weld seams 122, 123 are produced from the direction of the outer surface 121 of the connecting section. There is thus at most a slight accumulation of material on the inner surface of the waveguide.

It should be pointed out that the connecting section 120 can function both as a connecting part and as a waveguide section. Particularly in the region of the projection, the connecting section has the same function in signal transmission as the waveguide section 110, 130.

FIGS. 4 to 7 show connection possibilities for waveguide sections which manage without a separate sleeve. In the examples of FIGS. 4 to 7, two components are welded to one another at a connection point. Instead of a separate connecting section 120, two sections 110, 120 with different properties are used at the locations to be welded. This means that a section 110 can contain a non-weldable material (preferably a non-weldable aluminum alloy), whereas the section 120 contains a weldable material at least at the connection point (preferably a weldable aluminum alloy).

FIG. 4 shows two sections 110, 120 which are welded to one another at the end faces of their ends to be connected. The cross section of the sections 110, 120 corresponds to one another and there is no sudden change in the cross section of the cavity at the connection point. The weld seam is produced by means of laser welding along the abutting end faces of the sections 110, 120.

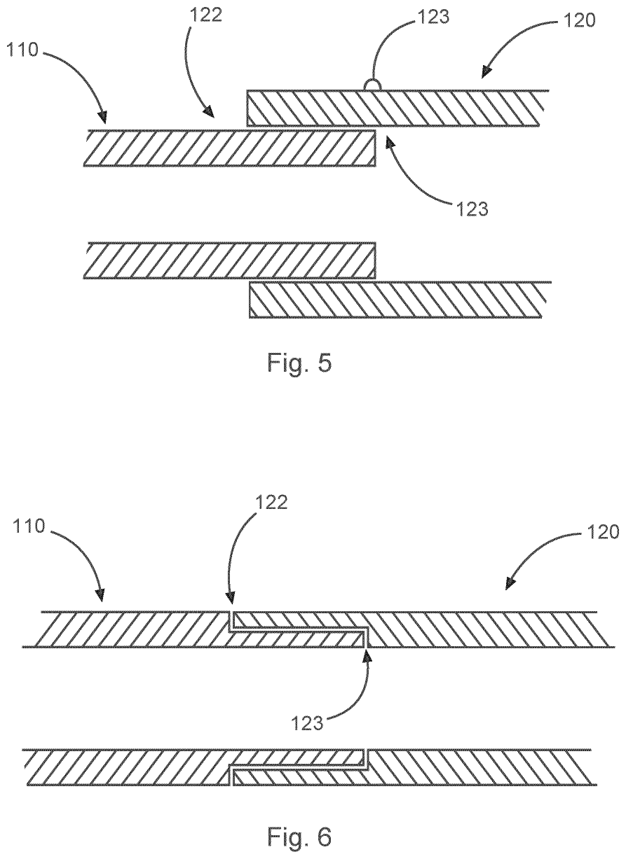

FIG. 5 shows an example in which two sections 110, 120 are connected to form a waveguide in which section 110 is inserted into section 120. The sections 110, 120 are welded to the other section 110, 120 at their respective ends. This welding process can be produced in each case starting from the outer surface of the sections 110, 120, as shown by way of example at the weld seams 122, 123.

FIG. 6 shows two sections 110, 120 inserted one into the other with stepped ends. The end of section 110 has a reduced outside diameter, whereas the end of section 120 has a widened inside diameter. The reduced outside diameter of the end of section 110 is inserted into the widened inside diameter of the end of section 120. Given the same length of the stepped ends (in the longitudinal direction of the waveguide, i.e. from left to right in FIG. 6), the ends overlap completely. The cross section of the cavity in the waveguide remains the same. In this example, the weld seams run in such a way that the ends of one section are welded to the other section.

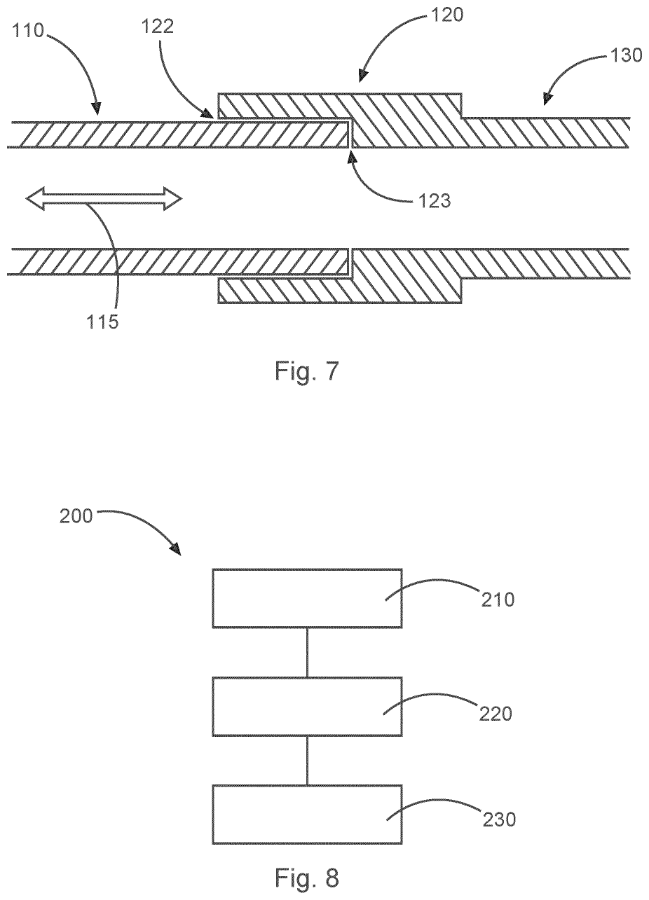

FIG. 7 shows a structure which can be regarded as a combination of the examples from FIG. 6 and FIGS. 1 to 3. A connecting section 120 is provided in a connecting region between the waveguide sections 110 and 130. Section 120 is formed integrally with section 130. Section 120 has a larger outside diameter than sections 110 and 130, but the inside diameter and also the cross section of the cavity remain the same in the longitudinal direction 115. Waveguide section 110 and also waveguide section 130 can thus be designed with a minimum wall thickness because the connecting section 120 has a widened outside diameter, thus enabling waveguide section 110 to be accommodated in the connecting section 120 or to be inserted into it without material of waveguide section 110 having to be removed at this location. In other words, the outside diameter of waveguide section 110 does not have to be reduced in order to insert waveguide section 110 into the connecting section 120.

In this example too, the weld seams are placed from the outside by means of laser welding, as described with reference to the other examples.

FIG. 8 shows, by way of example, the sequence of a method 200 for producing a waveguide according to the principles described herein. In a first step 210, a first waveguide section is provided, the first waveguide section containing a non-weldable material (preferably a non-weldable aluminum alloy). In a second step 220, a connecting section is provided, the connecting section containing a weldable material (preferably a weldable aluminum alloy). In a third step 230, a welded connection is produced between the first waveguide section and the connecting section by means of laser welding.

This method makes it possible to dispense with complex methods such as salt bath brazing and to replace such methods by laser welding. It is also possible to dispense with a welding filler material because the weldable material forms the melt required for the welded connection.

In addition, it should be noted that “comprising” or “having” does not exclude other elements or steps and “a” or “an” does not exclude a multiplicity. Furthermore, it should be noted that features or steps which have been described with reference to one of the above exemplary embodiments can also be used in combination with other features or steps of other exemplary embodiments described above. Reference signs in the claims are not to be regarded as a restriction.

### LIST OF REFERENCE SIGNS

100 waveguide
105 cavity
110 first waveguide section
111 flange
115 longitudinal direction
120 connecting section
121 outer surface
122 first weld seam
123 second weld seam
124 inner surface
125 projection
126 height
127 abutment surface
128 first opening
129 second opening
130 second waveguide section
131 flange
132 weld seam
133 weld seam

1. A method for producing a waveguide,
wherein the waveguide has a first waveguide section and a connecting section;
wherein the first waveguide section contains a non-weldable aluminum alloy;
wherein the connecting section contains a weldable aluminum alloy;
wherein the method comprises the step of:
connecting the first waveguide section to the connecting section by a laser welding method.

2. The method as claimed in claim 1,
wherein the method further comprises:
placing the connecting section with respect to the first waveguide section, such that the connecting section rests against the first waveguide section at least pointwise; and
connecting the first waveguide section to the connecting section by the laser welding method where the connecting section rests against the first waveguide section.

3. The method as claimed in claim 1,
wherein the method further comprises:
placing the connecting section with respect to the first waveguide section, such that the connecting section partially overlaps the first waveguide section in the longitudinal direction of the first waveguide section.

4. The method as claimed in claim 3,
wherein the connecting section completely surrounds the first waveguide section in the circumferential direction.

5. The method as claimed in claim 1,
wherein the waveguide comprises a second waveguide section; and
wherein the second waveguide section adjoins the connecting section.

6. The method as claimed in claim 5,
wherein the second waveguide section is of one-piece design with the connecting section.

7. The method as claimed in claim 5,
wherein the connecting section is configured as a sleeve which at least partially overlaps both the first waveguide section and the second waveguide section in the longitudinal direction and completely surrounds them in the circumferential direction on a respective outer surface, wherein the sleeve is connected to the first waveguide section and the second waveguide section by laser welding.

8. The method as claimed in claim 5,
wherein the second waveguide section contains a non-weldable aluminum alloy.

9. The method as claimed in claim 1,
wherein the weldable aluminum alloy has a silicon content of more than 3 percent by weight;
wherein the non-weldable aluminum alloy has a silicon content of at most 3 percent by weight.

10. A waveguide for transmitting high-frequency signals, having:
a first waveguide section comprising a non-weldable aluminum alloy;
a connecting section containing a weldable aluminum alloy;
wherein the first waveguide section and the connecting section are connected to one another by a laser weld seam.
